(19) United States
(12) Patent Application Publication
(10) Pub. No.: US 2002/0091540 A1
(43) Pub. Date: Jul. 11, 2002

(54) Method and system for emergency assistance management

(76) Inventors: Mark Stumne, Maple Grove, MN (US); David Simmons, Andover, MN (US); Dennis Sorenson, Shakopee, MN (US); Dale Hunter, North Branch, MN (US); Wally Kedrowski, W. St. Paul, MN (US); Michael Magnusson, Champlin, MN (US)

Correspondence Address: Devan V. Padmanabhan, Dorsey & Whitney LLP, 220 South Sixth Street, Minneapolis, MN, 55402-1498, US

(21) Appl. No.: 09/841,842

(22) Filed: Apr. 25, 2001

Related U.S. Application Data
(60) Provisional application No. 60/260,734, filed on Jan. 10, 2001.

(51) Int. Cl. G06F 17/60

(52) U.S. Cl. 705/1

(57) ABSTRACT

The present invention relates to the management of an emergency assistance program. The invention provides for the management of an emergency situation through incident tracking, invoicing, billing, and reporting. It further provides various automated actions to manage the situation quickly and efficiently.

### CROSS-REFERENCE TO RELATED APPLICATION(S)

This application claims priority from U.S. Provisional Application No. 60/260,734, filed Jan. 10, 2001, entitled “Method and System for Emergency Assistance Management,” by Stumne et al., which is hereby incorporated by reference in its entirety.

### FIELD

The present invention relates to computer software and database management systems. It provides a method and system for providing emergency or repair assistance. More particularly, the invention relates to a method and system for managing a roadside assistance program.

### BACKGROUND

Known repair assistance systems rely on separate, independent programs for each system step. Separate software components are utilized for incident management, invoicing, and billing. The components do not interact, because each is designed to operate independently. The incident management software is manipulated by advisors to provide emergency assistance to the operator. After providing on-site assistance at the request of the assistance management provider, the vendor submits a hardcopy of its invoice. The provider manually compares the invoice to the work authorization information, and resolves any discrepancies. The appropriate invoicing paperwork is provided to the accounts receivable department for billing. The accounts receivable department manually enters the information into the billing software, and the bill is sent to the customer.

The typical repair assistance process outlined above has a number of disadvantages. The disjointed process flow using the separate programs is complex and difficult to understand, thus requiring costly and lengthy provider employee training. Process operation is time-consuming and inefficient, requiring substantial manual input. Billing turnaround, furthermore, is slow. The customer is not invoiced until a paper invoice is received from the vendor.

Reporting is very difficult due to the disjointed structure of the system. Because each software program is based on a different platform and operating system, even the most basic reporting is a massive undertaking. Customer updates, in addition, are cumbersome and inefficient for both the customer and the provider. The customer must call to request information about an emergency situation. The provider must then allocate resources to print and fax documentation to the customer.

The need for separate components in the typical prior art system increases the risk and incidence of system failure and resulting downtime. Furthermore, the advisors must be centrally located to access the known system, creating a real estate burden.

There is a need in the art for an integrated emergency assistance method and system adapted to easily perform incident tracking, invoicing, billing, and reporting with few maintenance problems. A need also exists for a fast, efficient emergency assistance method and system that is easy to learn and requires few resources. A further need exists for an automated emergency assistance method and system that eliminates much of the human intervention and inefficient use of hardcopies. Furthermore, a need exists for a flexible emergency assistance method and system allowing for off-site access by users, vendors, and customers.

### SUMMARY OF THE INVENTION

One embodiment of the present invention provides a method for managing an emergency assistance system, including interaction between the operator, vendor, and customer. The invention provides for receiving incident information and storing the information in an incident tracking file. It further provides for receiving invoice information from the vendor, verifying the information, and generating a bill.

In one embodiment, the present invention also provides for generating a report from at least the incident information. In another embodiment, the invention allows for searching for and selecting a vendor and recording any vendor contact information, which becomes a part of the incident tracking file. In further embodiments, the present invention automatically creates at least a portion of the incident information from previously entered incident information. Another embodiment provides for automatically generating a work authorization file which is made up of invoice information and incident information.

The present invention further provides for an automated system for emergency assistance. The system is made up at least one client, a server, and a communication path electronically linking the client to the server. The server has memory, a processor, an incident database, and an invoice database. The processor receives incident information, stores the information in the incident database, and tracks the information. The processor also automatically creates at least some of the incident information. It further receives, stores, automatically verifies, and transmits invoice information. In addition, the process can generate a bill and/or a report, and transmit the bill.

While several embodiments are disclosed, still other embodiments of the present invention will become apparent to those skilled in the art from the following detailed description, wherein is shown and described only the embodiments of the invention, by way of illustration, of the best modes contemplated for carrying out the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flow chart illustrating the basic steps of one embodiment of the present invention.

FIG. 2 is a block diagram illustrating the interaction between the components of the present invention.

FIG. 3 is a flow chart depicting one embodiment of the invention.

FIG. 4 is a flow chart showing one embodiment of a search procedure of the present invention.

FIG. 5 is a flow chart illustrating one embodiment for creating a new incident in the present invention.

FIG. 6 is a flow chart showing one embodiment for adding a new inventor to the system and method of the present invention.

FIG. 7 is a flow chart depicting one embodiment of a phone log entry.

FIG. 8 is a flow chart illustrating one embodiment of the creation of a work authorization.

FIG. 9 is a flow chart showing one embodiment for adding new information to the customer parameter database.

FIG. 10 is a flow chart showing one embodiment for creating a reminder.

FIG. 11 is a flow chart depicting one embodiment of a load swap.

FIG. 12 is a flow chart illustrating one embodiment for adding new asset information.

FIG. 13 is a flow chart showing one embodiment of the invoicing component of the present invention.

FIG. 14 is a flow chart depicting another embodiment of the invoicing component of the present invention.

FIG. 15 is a flow chart illustrating another embodiment of the invoicing component of the present invention.

FIG. 16 is a flow chart showing another embodiment of the invoicing component of the present invention.

FIG. 17 is a flow chart depicting one embodiment of the reporting component of the present invention.

FIG. 18 is a sample screen display for performing an incident search.

FIG. 19 is a sample screen display for entering or reviewing incident information.

FIG. 20 is a sample screen display for performing a vendor search.

FIG. 21 is a sample screen display for creating a reminder.

FIG. 22 is a sample screen display for recording a contact in a phone log.

FIG. 23 is a sample screen display for entering new invoice information.

FIG. 24 is a sample screen display for requesting a bill.

FIG. 25 is a sample screen display for requesting a report.

FIG. 26 is a block diagram overview of a client-server system in which the present invention functions.

### DETAILED DESCRIPTION

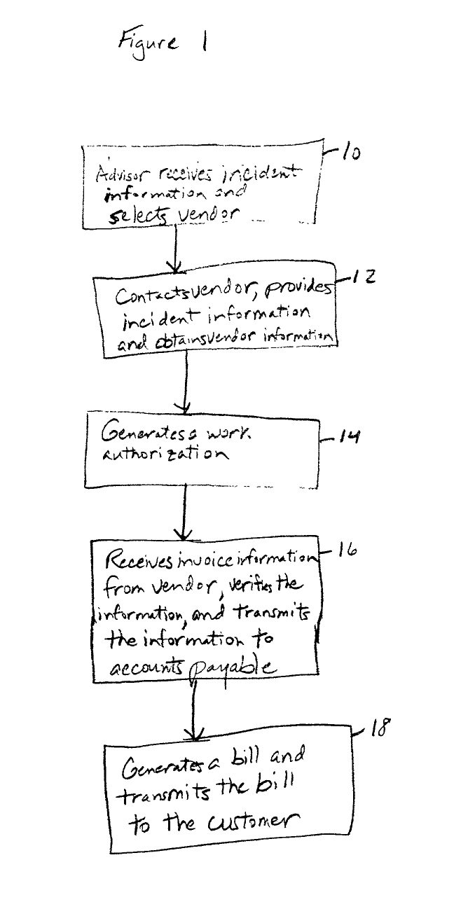

FIG. 1 is a flow chart illustrating the basic steps of emergency assistance management according to one embodiment of the present invention. As shown in FIG. 1, the present embodiment of the invention provides emergency incident management by receiving incident information and selecting a vendor 10, contacting the vendor to exchange information 12, generating a work authorization 14, receiving, verifying, and transmitting invoice information for payment 16, and generating and transmitting a bill 18.

As shown in FIG. 1, the incident information in one embodiment is received by an advisor 10. The advisor receives the information from the operator by telephone. In other embodiments, the advisor receives the information by another method of communication, such as the Internet. The operator provides relevant incident information, such as location and the vehicle-related problem. In another embodiment, the operator provides information about a different type of emergency, such as a heavy equipment breakdown. The present invention then allows the advisor to select a vendor 10 based on the incident information.

FIG. 1 shows that one embodiment allows the advisor to contact the selected vendor to exchange information 12. The advisor informs the vendor of the emergency and the location. In other embodiments, the advisor may also provide the vendor with specific information about the vehicle and its condition. The vendor provides an estimate of the assistance cost. In another embodiment, the vendor provides further information, such as a time-to-completion estimate.

The embodiment shown in FIG. 1 also allows the advisor to create a work authorization 14 using incident and vendor information.

One embodiment of the present invention, as shown in FIG. 1, provides for receiving invoice information from the vendor, verifying the information, and transmitting it to accounts payable 16. The vendor submits the invoice information over the Internet. In other embodiments, the vendor submits the information using an telephonic interactive voice response system (IVR) or by any other form of communication. The present invention verifies the submitted invoice information automatically in one embodiment by comparing the invoice information to the work authorization information. In other embodiments, the verification process is performed manually. After verification, the invoice information is forwarded in one embodiment to accounts payable for payment. In another embodiment, the information is transmitted to a location from which it can be downloaded into an external system. In yet another embodiment, the invoice information is converted into a method of payment and sent directly to the vendor.

As further shown in FIG. 1, one embodiment of the present invention generates a bill based on the incident, vendor, and invoice information and transmits it to the customer 18. In one embodiment, the bill generation occurs automatically, while in another embodiment the bill is generated through prompting by an advisor. The bill is then transmitted to the customer. In one embodiment, the present invention prints the bill and it is sent to the customer by conventional mail. In another embodiment, the bill is transmitted to the customer electronically.

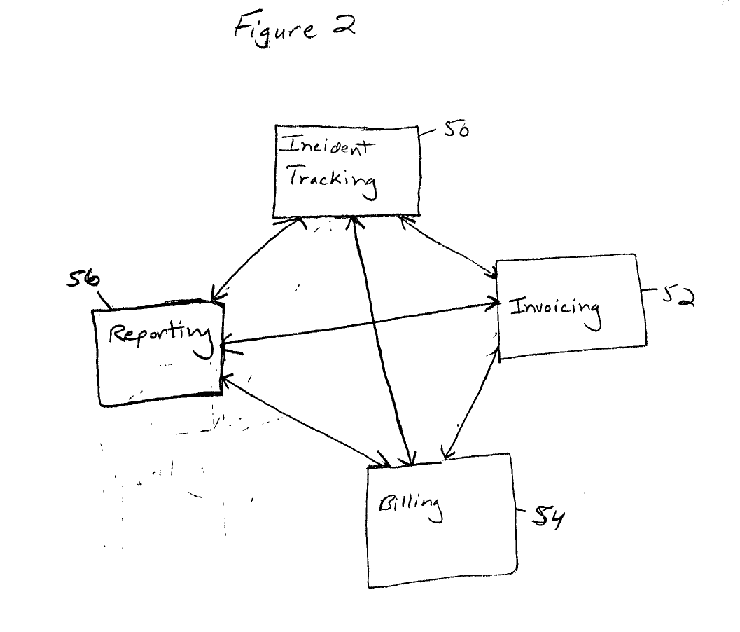

FIG. 2 depicts one embodiment of the interaction between four interrelated emergency assistance management components. The embodiment comprises components for incident tracking 50, invoicing 52, billing 54, and reporting 56. The present invention provides for interaction between the four components. From a client computer, an advisor can access any of the components. The embodiment further allows immediate access to any component interface from the interface of any other component. For example, the user may access the billing component 54 from the incident tracking component 50 in order to create a bill for a customer. Typically, access is initially provided in the form of appropriate component buttons available at a main interface. In some embodiments, access is provided to every component in the form of appropriate component buttons available at any interface.

### A. Operation of the Invention

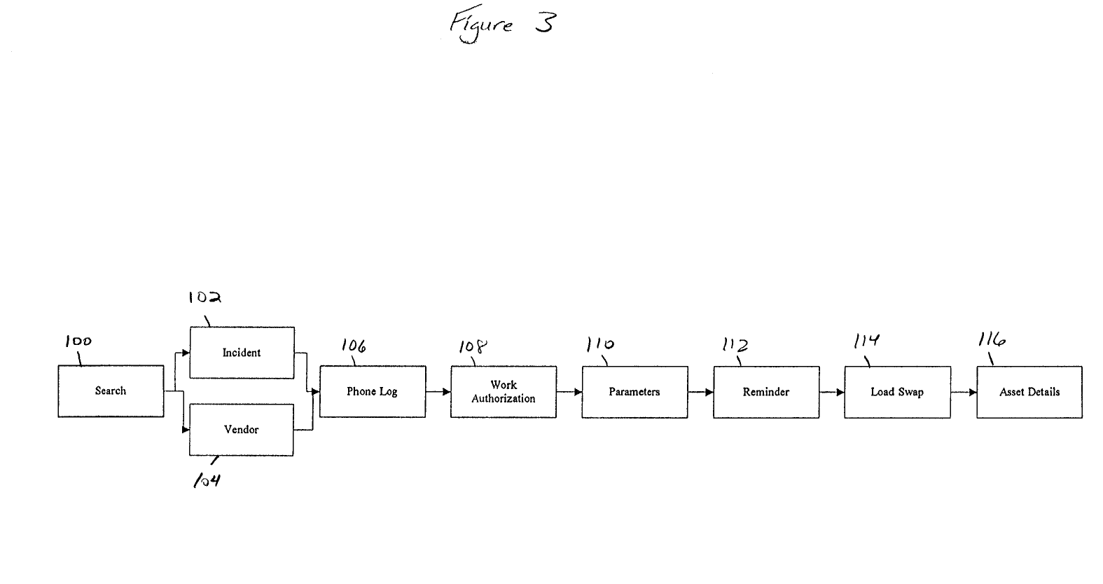

In operation as depicted in FIG. 3, incident tracking typically begins with a call from an equipment operator. The advisor may perform a search 100. In some embodiments, the advisor performs an incident search 102, which may involve a search of an incident database to identify an existing incident in the database to which the call is related. The present invention allows the advisor to perform a search of any field of the incident database. In other embodiments, the advisor performs a vendor search 104 to identify an appropriate vendor for performing on-site assistance. Typically, the advisor will maintain information of any incoming or outgoing phone calls by creating a phone log 106. In addition, in one embodiment the advisor completes a work authorization 108, which includes the inputting of data regarding the vendor authorized to perform the on-site assistance and the estimated expense. Some work authorization fields may not need to be filled by a user, because some embodiments of the present invention provide for automatic insertion of previously-entered data into appropriate database fields.

As further shown in FIG. 3, the advisor may be required in some embodiments to access the parameters 110, which provide specific customer-related information. The information may relate to cost limits, desired vendors, and any other relevant customer preferences or requirements. To access the parameters 110, the present invention typically allows the advisor to perform a search for the appropriate customer parameter information. Other embodiments allow the advisor to update or input new customer parameter information. The advisor may also need to create a reminder 112, which the system and method of the present invention stores and automatically transmits to the requested user at the requested date and time. If the equipment is transporting some form of cargo or shipment, one embodiment allows the advisor to record a load swap 114 if it becomes necessary to provide alternative equipment. In some embodiments, certain load swap fields will be completed automatically by the present invention. One embodiment also provides for asset details 116, which allows the advisor to access information specific to the equipment experiencing the emergency. In other embodiments, the advisor may also input new data regarding the current emergency situation into the asset details table.

Alternative embodiments may allow the advisor to perform the activities depicted in FIG. 3 in any order. Some embodiments may also allow for further activities necessary for emergency assistance. For example, one embodiment may allow the advisor to search for and contact additional services, such as a transportation service to transport the equipment operator(s) to a desired location for lodging, food, or any other reason while waiting for assistance to be completed. In further alternative embodiments, the present invention allows the customer, as a user at a client computer, to access an existing incident. In some embodiments, the present invention provides the customer with read-only access, which prohibits the customer from editing the information.

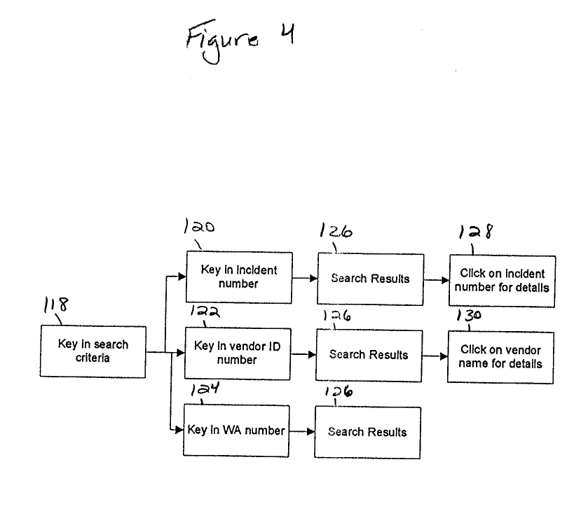

FIG. 4 depicts a search step of one embodiment of the present invention. The system and method of the invention allows the advisor to input the appropriate criteria 118 at any time from any component of the invention. The advisor may want to perform an incident search for some reason. For example, an incoming call may be related to an existing incident, or the advisor may need to update an existing incident for some reason. In one embodiment, to perform the incident search, the advisor inputs an incident number 120. Based on the search results 126, the advisor will likely choose an incident by clicking on the appropriate incident number 128. In another embodiment, the advisor performs a work authorization search by inputting the work authorization number 124. In alternative embodiments, the present invention allows the advisor to search any field of the appropriate database.

As shown in FIG. 4, the invention also allows the advisor to perform a vendor search. In the embodiment depicted in FIG. 4, the advisor is allowed to perform the vendor search by inputting a vendor I.D. number 122. In an alternative embodiment, the present invention prompts the advisor to search by one of two methods: 1) city and state, or 2) radius. In further alternative embodiments, the advisor narrows the vendor search by applying a “filter.” The present invention prompts the advisor to provide parameters for filtering the search. Filters may include type, class, affiliation, franchise, and capabilities. For example, the advisor may want to narrow the search to a particular class of vendor, such as a tire repair shop or an auto body repair shop. The present invention provides search results 126, and the advisor can select a vendor from the results 130.

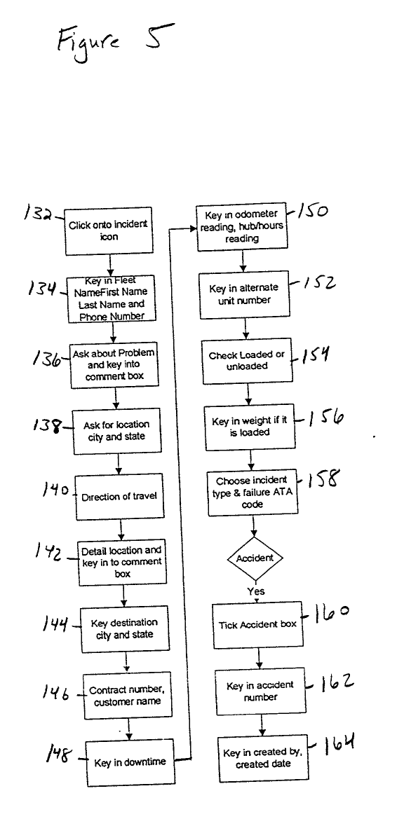

If the call pertains to a new emergency situation, a new incident must be created. FIG. 5 depicts one embodiment providing for the creation of a new incident. If the incident interface is not already available, the advisor selects the “incident” button to gain access 132. The present invention will call for customer and contact information, such as the fleet name, the caller's name, and the caller's phone number 134. The present invention will also allow the advisor to input specific information about the problem into a comment box 136. The advisor will also input details regarding the emergency situation, including the location 138, the direction of travel 140, location details 142, and destination 144. The customer name and a contract number are inputted 146 as well. The contract number aids the customer in tracking the emergency situation. Other information to be entered includes the vehicle downtime 148, the vehicle odometer and/or hours reading 150, an alternate unit number 152 (allowing for the insertion of customer-based unit identification, when appropriate), whether the vehicle is loaded 154, and the weight if the vehicle is loaded 156. The present embodiment allows the advisor to select an incident type and a failure ATA code 158. The failure ATA Code identifies the primary cause of the emergency in the form of a standard code provided by the American Trucking Association. The ATA Code information can be used to help customers analyze and maintain their equipment. If the emergency situation was created by an accident, the advisor can indicate that by selecting the appropriate accident box 160 and inputting an accident number 162. The advisor also inputs the date that the new incident was created and the name of the advisor who created it 164.

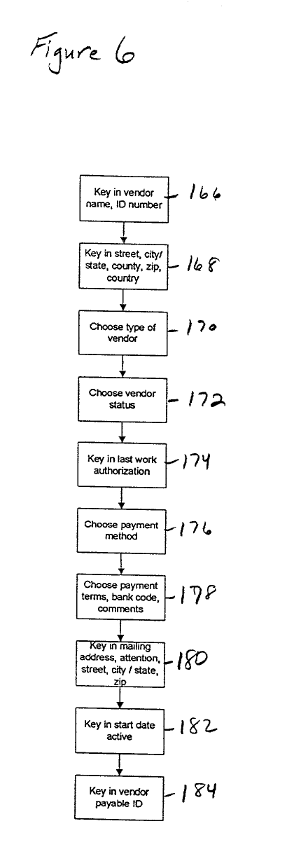

If the advisor discovers a new vendor or a vendor search during an emergency situation is unsuccessful, the advisor may need to add a new vendor into the appropriate database for later recall. FIG. 6 depicts an embodiment in which an advisor may input a new vendor. The advisor inputs the vendor's name and I.D. number 166, the vendor's address 168, the type of vendor 170, the vendor status 172. In some embodiments, if the vendor performed on-site assistance prior to entry into the system, the advisor enters the last work authorization involving the vendor 174. The advisor also inputs the vendor's preferred payment method 176, plus the vendor's preferred payment terms and any bank information or comments 178. The present invention also provides for entering the vendor's mailing address 180, the vendor's active start date 182, and a vendor payable I.D. 184.

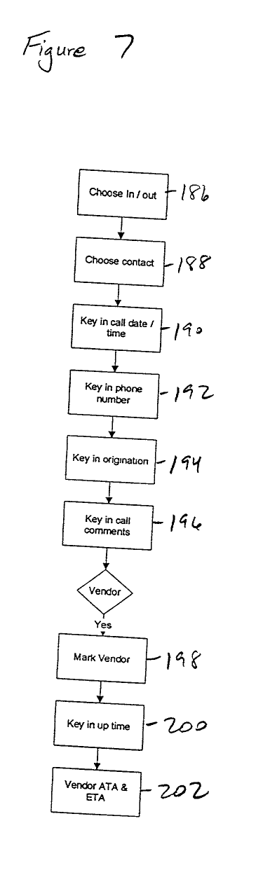

In the embodiment shown in FIG. 7, the advisor creates a phone log. This embodiment of the present invention allows the advisor to indicate whether the call is incoming or outgoing 186. The embodiment also allows the advisor to select a contact from those already in a database 188. In an alternative embodiment, the present invention allows the advisor to insert a new contact. The advisor inputs appropriate information, such as the date and time of the call 190, the phone number 192, the origination of the call 194, and any appropriate comments 196.

In some embodiments, the phone call shown in FIG. 7 relates to a vendor. When a vendor agrees to perform the emergency assistance, the present embodiment allows the advisor to indicate which vendor agreed by “marking” the appropriate vendor 198. In one embodiment, “marking” the vendor causes a change in the background color of the phone log display screen, thereby highlighting and allowing for rapid identification of the appropriate vendor. The present embodiment further allows the advisor to input the up time 200 (the time when the equipment is restored to operational condition). The invention uses the “up time” information to calculate and report the total amount of time that the equipment was non-operational. The present embodiment further allows for the input of the estimated time of arrival (ETA) and actual time of arrival (ATA) of the vendor at the emergency site 202. Inputting the ETA and ATA allows for consistent communication regarding arrival information to operators, customers, and provider employees. In one embodiment, the ETA and ATA information determines the timing of an automatic reminder. In another embodiment, the information is useful for vendor evaluation.

In some embodiments, several of the fields of information are automatically inputted with appropriate information previously entered during previous steps of the present invention. In alternative embodiments, the phone log creation may involve different or additional steps, such as inputting the customer name or automatically providing information regarding the customer's established parameters for on-site assistance.

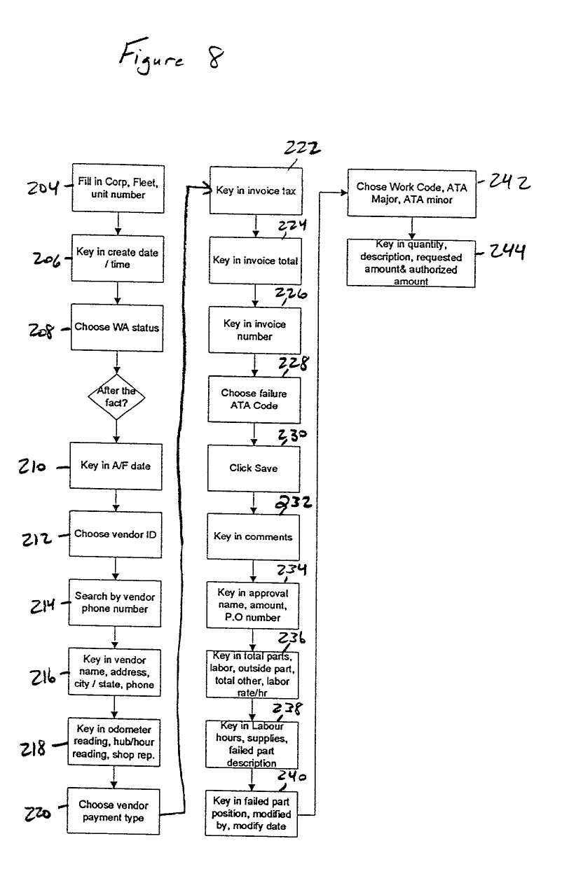

One embodiment of the creation of a work authorization is depicted in FIG. 8. The present invention allows the advisor or other user to input information about the corporation, fleet, and/or unit number of the equipment involved 204, the date and time of creation of the work authorization 206, and the status of the work authorization 208. In another embodiment, when a vendor performs the emergency assistance without prior authorization, the advisor identifies the authorization as “after the fact” (“A/F”) and inputs the A/F date 210. The “after the fact” designation indicates to the customer and others that the authorization and price negotiations occurred at the local level without any involvement by the provider. In the present embodiment, the advisor selects an appropriate vendor, inputs the vendor I.D. 212 and retrieves information about the vendor by performing a search based on the vendor phone number 214. Upon vendor selection, one embodiment allows the advisor to input such vendor information as address and phone number 216, in addition to such information as 1) an odometer reading, a hub/hour reading, and the shop representative 218, 2) the appropriate vendor payment type 220, 3) the invoice tax 222, 4) the invoice total 224, 5) the invoice number 226, and 6) the failure ATA Code 228. In the present embodiment, the advisor prompts the system and method of the present invention to save the inputted data 230. In another embodiment, the advisor inputs appropriate comments 232 and specific work information, such as approval data and limits 234, subtotals by category such as parts, labor, and the like 236, expense for labor hours and supplies 238, and information about a failed part if relevant 240. In one embodiment, the advisor assigns certain codes to the work authorization, including a work code 242. Other work authorization information that is allowed to be inputted includes quantity information, a description of any parts used, the amount requested by the vendor, and the authorized amount 244.

In an alternative embodiment, the present invention automatically displays a work authorization history if incident history exists. If the advisor determines that the active work authorization is part of the previously inputted work authorization, then the present invention allows the advisor to edit the existing work authorization. However, if the advisor determines that the active work authorization is not related to the work authorization history, the present invention allows the advisor to complete a new work authorization. If no work authorization history exists, the present embodiment may automatically display a new work authorization for the advisor to complete.

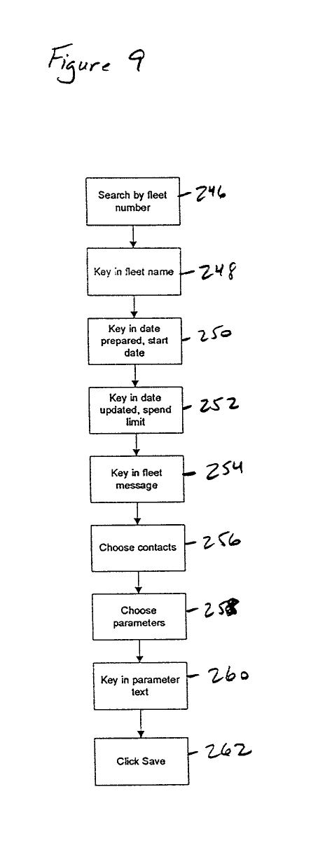

Parameters can be established by the customer to ensure implementation of the customer's specific desires and limitations regarding emergency assistance. For example, the customer may want to place a ceiling on emergency assistance spending, or ensure that specific vendors are utilized. FIG. 9 depicts one embodiment by which parameters are established or updated. The advisor may need to search for the appropriate fleet by performing a fleet number search 246. Alternatively, if no parameters have been previously entered for the vendor, the advisor inputs the vendor name 248 and information about the date that the parameters were prepared and the start date for implementation 250. If parameters previously existed, the advisor inputs the date the information was updated and establishes a spending limit where appropriate 252. In some embodiments such as the one shown in FIG. 9, the advisor inputs such information as a fleet message 254 and relevant contact information 256. To input the parameter information in the present embodiment, the advisor selects the relevant parameter 258, inputs the appropriate parameter text 260, and saves 262.

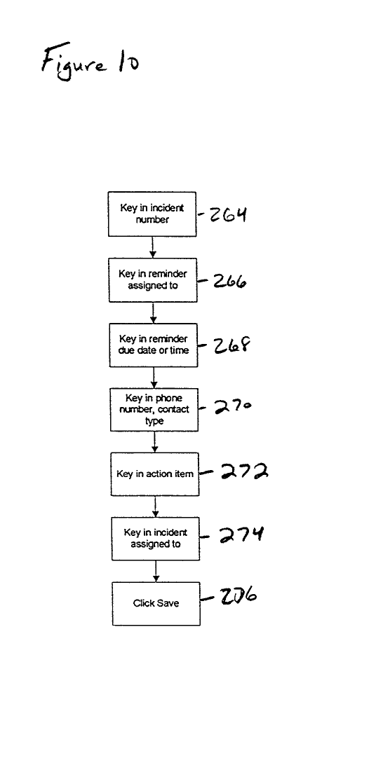

The present invention provides for the creation of an automatic reminder function by which an advisor or another user at a client computer may receive an electronic notice or reminder of some action that must be taken. The reminder may be created by several different methods. FIG. 10 depicts one embodiment for creating a reminder. The advisor or other user inputs the incident number 264, the user to whom the reminder is assigned 266, and the date or time that the reminder is due 268. In some embodiments, if the reminder originated from a call, the advisor inputs relevant contact information including a phone number and contact type 270. In alternative embodiments, the relevant contact information is automatically inputted by the present invention into the appropriate reminder fields. The advisor also inputs text, called an “action item,” to describe the action required upon receipt of the reminder 272. In some embodiments, the advisor inputs information regarding the incident to which the reminder is assigned 274. In alternative embodiments, the present invention will automatically input the incident information into the appropriate fields. The present invention also allows the advisor or other user to save the inputted information 276. At the appropriate time and date as provided by the user, the present invention automatically sends the reminder to the requested user.

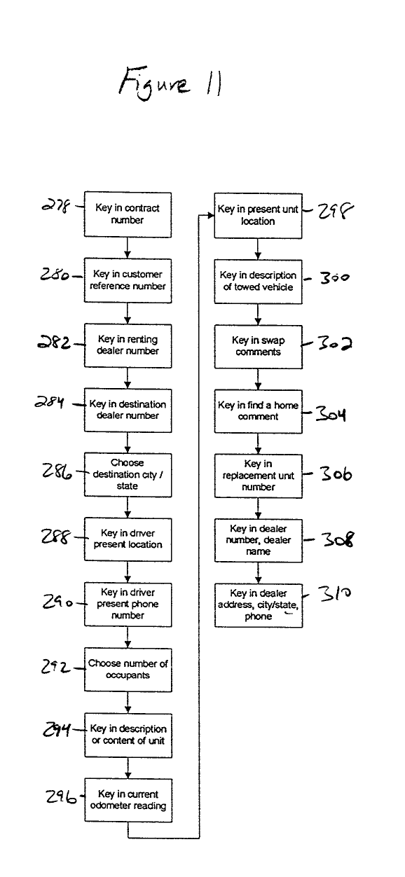

The advisor is allowed to order a load swap when it is clear that the equipment experiencing the emergency will not be repaired in a timely manner. For example, if no appropriate vendor can be located, no new vendors are available and an impending deadline exists, the advisor may determine that a load swap is necessary. In alternative embodiments, the load swap may be performed for any reason requiring expedited transportation. FIG. 11 depicts one embodiment involving the performance of a load swap. The advisor inputs a contract number 278 and identifies the customer by inputting a customer reference number 280. The advisor includes the rental information by inputting the identification number of the renting dealer 282, the identification number of the destination dealer 284, and the destination city and state 286. In addition, the advisor inputs specific information about the load swap, including the present location of the driver 288, the present phone number of the driver 290, the number of occupants in the equipment experiencing the emergency situation 292, a description of the unit and/or its contents 294, a current reading of the odometer 296, the present location of the specific unit 298. In some embodiments, certain specific information need not be entered by the advisor, because the present invention automatically retrieves the previously-inputted information and inserts in the appropriate load swap field. In one embodiment, the advisor includes a description if the vehicle is towed 300. The advisor will also input any further comments or description regarding the swap 302 if necessary. In another embodiment, “find a home” comments are included 304 when the vehicle is repaired at a non-customer location and must be brought back to a customer location. The “find a home” field allows for tracking and follow-up of these non-customer location repairs. In a further embodiment, the advisor enters additional information, including 1) the replacement unit number 306, 2) the dealer name and number 308, and 3) the dealer address and phone number 310.

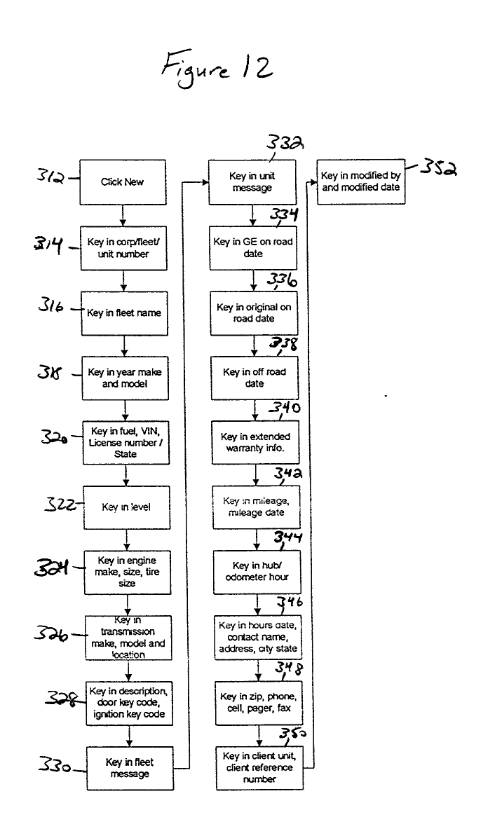

In some embodiments, each piece of equipment which is a candidate for on-site assistance is entered as an “asset” into the system or method of the present invention. FIG. 12 depicts one method of inputting asset information. The advisor selects the “new” button 312 to indicate that no information regarding the specific asset has previously been inputted. The advisor links the new equipment to a customer by inputting a corporate, fleet, or unit number 314, along with the fleet name 316. The advisor also inputs specific information about the asset, including the year, make and model 318, the engine make, engine size, and tire size 324, the transmission make, model, and location 326, and the door key and ignition key codes 328. Other descriptive information is also entered, including the VIN, license number, and licensing state 320, and the asset level 322. Asset level information 322 relates to the location of the asset in the customer's structural hierarchy. For example, in one embodiment the levels may be designated as follows: level 1=customer; level 2=region; level 3=state; level 4=city; level 5=store number; and level 6=department number. Any relevant information regarding the fleet or the specific unit is inputted as a fleet message 330 or a unit message 332. The advisor also inputs the date that the equipment was first placed into operation under the on-site assistance program (the “GE on road date”) 334, the original date that the equipment was first used (the “original on road date”) 336, and the date the equipment was taken out of operation (the “off road date”) 338. Other information that may be inputted includes extended warranty information 340 (which may be useful when selecting a vendor), mileage information 342, odometer information 344, and operator information such as contact name and address 346 and contact phone numbers 348. The advisor also inputs a unit and/or reference number 350, along with the name of the user who entered the information and the date it was inputted 352.

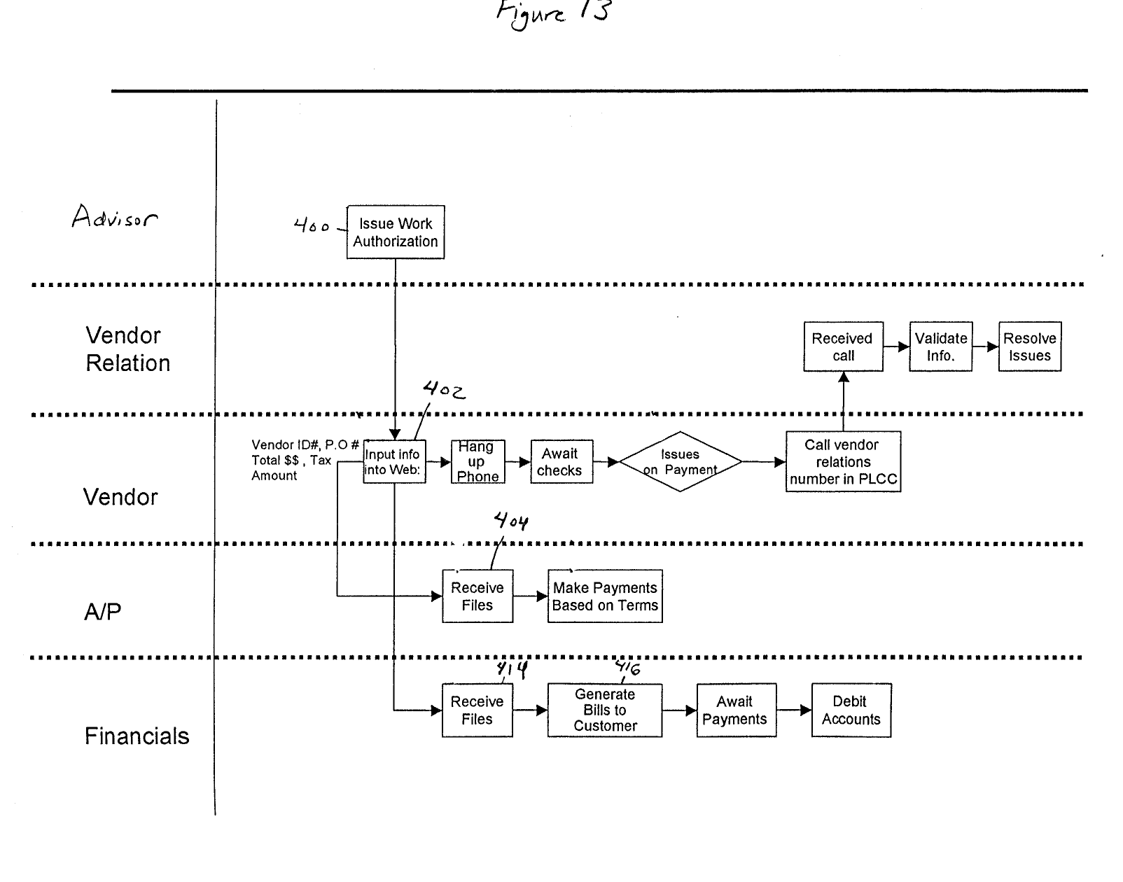

As depicted in FIG. 13, one embodiment performs invoicing functions. The vendor is allowed to submit an invoice electronically, telephonically, by hardcopy, or by any other method. The embodiment of FIG. 13 allows the vendor to access an invoice interface over the Internet through a client computer. Typically, appropriate work authorization information is previously inputted by the advisor 400. A vendor inputs the appropriate information regarding the vendor-provided emergency assistance 402 through limited access to the present invention on a client computer Internet browser. The system and method of the present invention automatically exports the invoice information to an internal invoice site 404 such as the accounts payable department for payment procedures. In other embodiments, the present invention, upon electronic submission of the invoice information, performs an automatic comparison of the submitted invoice with the amount inputted into the work authorization database. If no discrepancies exist, the information will be automatically transmitted to the internal invoice site 404. If a discrepancy does exist, the present invention will automatically inform the vendor to contact an appropriate individual. In other embodiments, the present invention automatically notifies an internal user of the discrepancy.

As shown further in FIG. 13, the present invention also allows for the performance of billing functions necessary to request payment from the customer. In the embodiment depicted in FIG. 13, the invention automatically compiles the billing information from the corrected invoice information, then calculates and formats the information into a bill file. In some embodiments, the billing files include a bill detail file and a bill summary file. The present invention can utilize the bill file to further automatically generate an interface accounts receivable file which is then exported to an internal billing site 414 for retrieval by an accounts receivable system, which then processes the file and generates the customer bill. In other embodiments, the invention retains the resulting billing file and automatically generates a bill to be sent to the customer 416. In further embodiments, the invention allows an advisor to request a customized bill. The customized bill may encompass a specified period, a specified number of incidents, or any other parameters provided by the advisor.

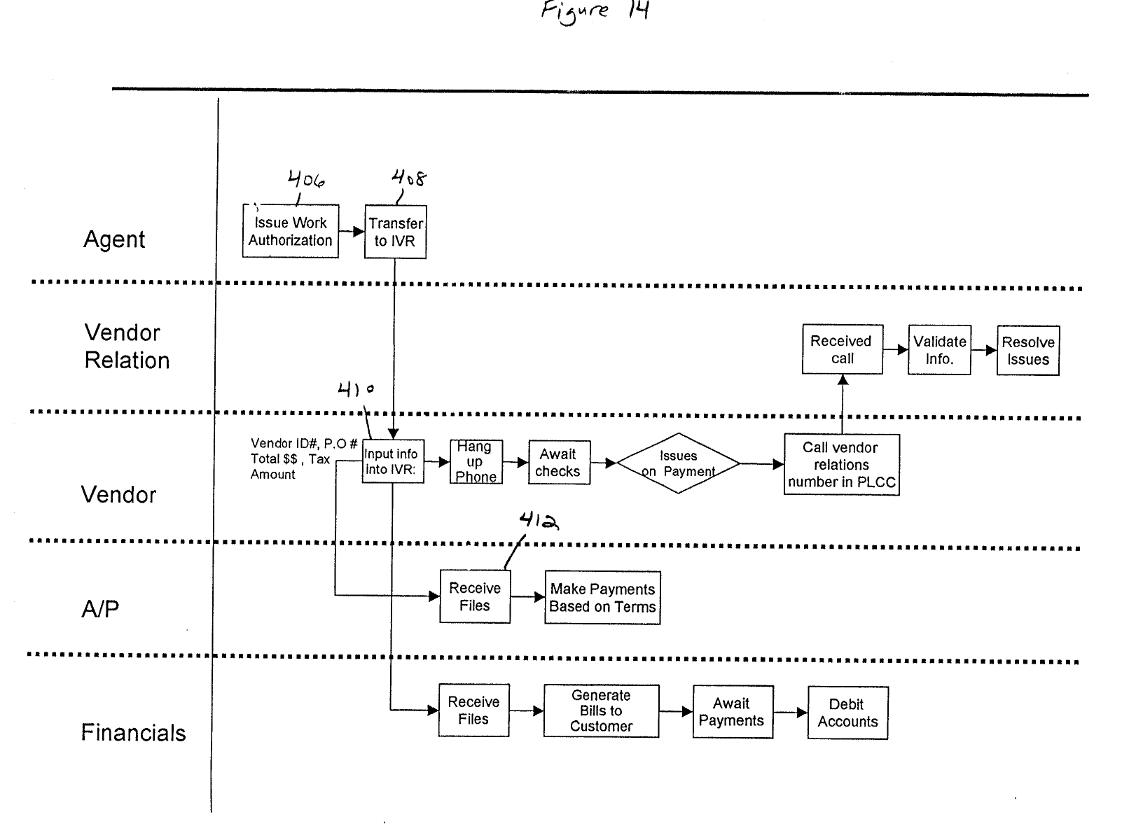

FIGS. 14, 15, and 16 depict other embodiments of the present invention allowing for invoice submission by the vendor. The embodiment shown in FIG. 14 depicts an interactive voice response (IVR) system. Upon issuance of the work authorization by the advisor 406, the system and method of the present invention allows for the transfer of the work authorization information to the IVR system 408. The embodiment allows the advisor to input the invoice or other information telephonically into the IVR system 410. The information is automatically exported to an internal invoice site 412.

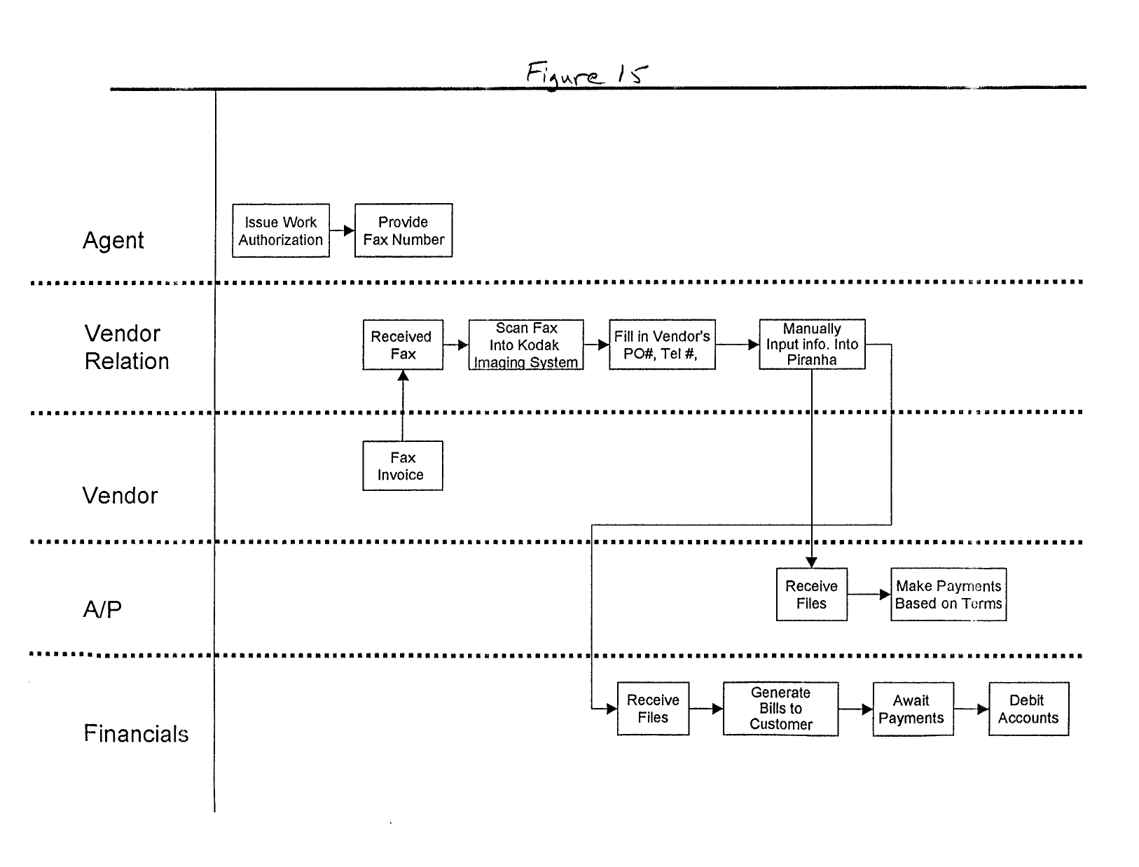

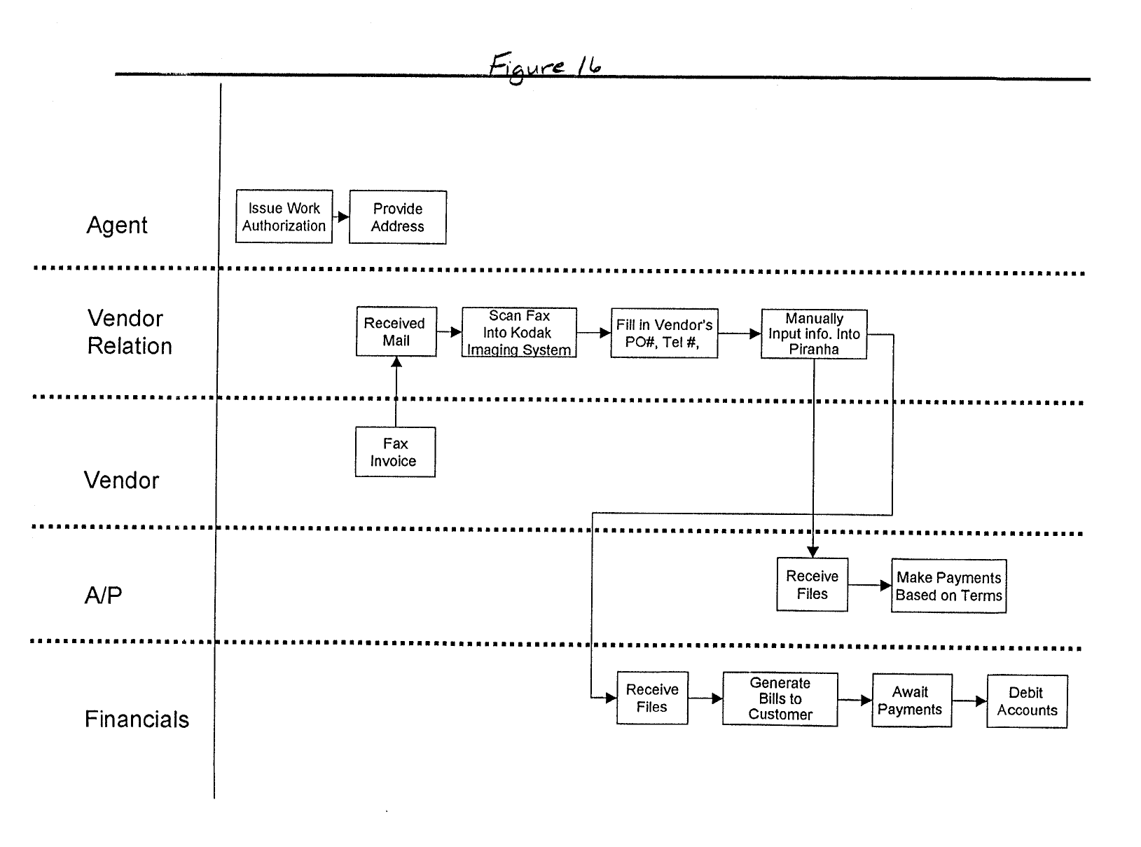

FIG. 15 shows the system and method of the present invention providing for fax payment. FIG. 16 depicts an embodiment providing for mail payment.

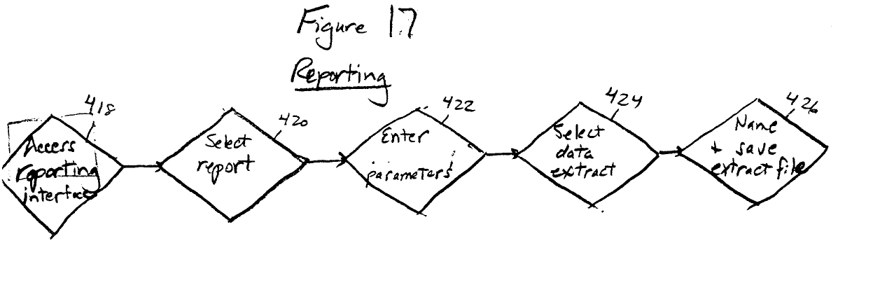

The present invention further provides a reporting component. In the embodiment shown in FIG. 17, the advisor accesses the reporting interface 418 and selects an appropriate report 420. In one embodiment, the advisor customizes the report by inputting the appropriate parameters 422 and selecting a data extract 424. The advisor saves the report as a file 426. In alternative embodiments, the customer or other external user is also allowed to access, select, and save such reports.

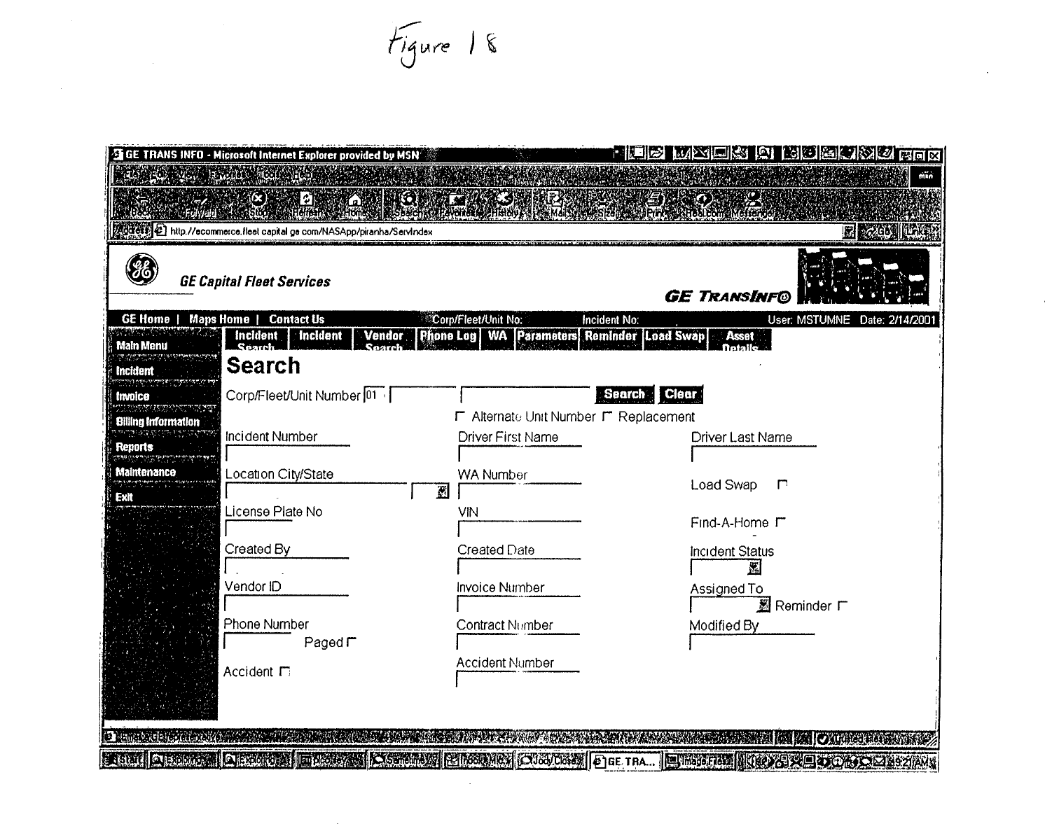

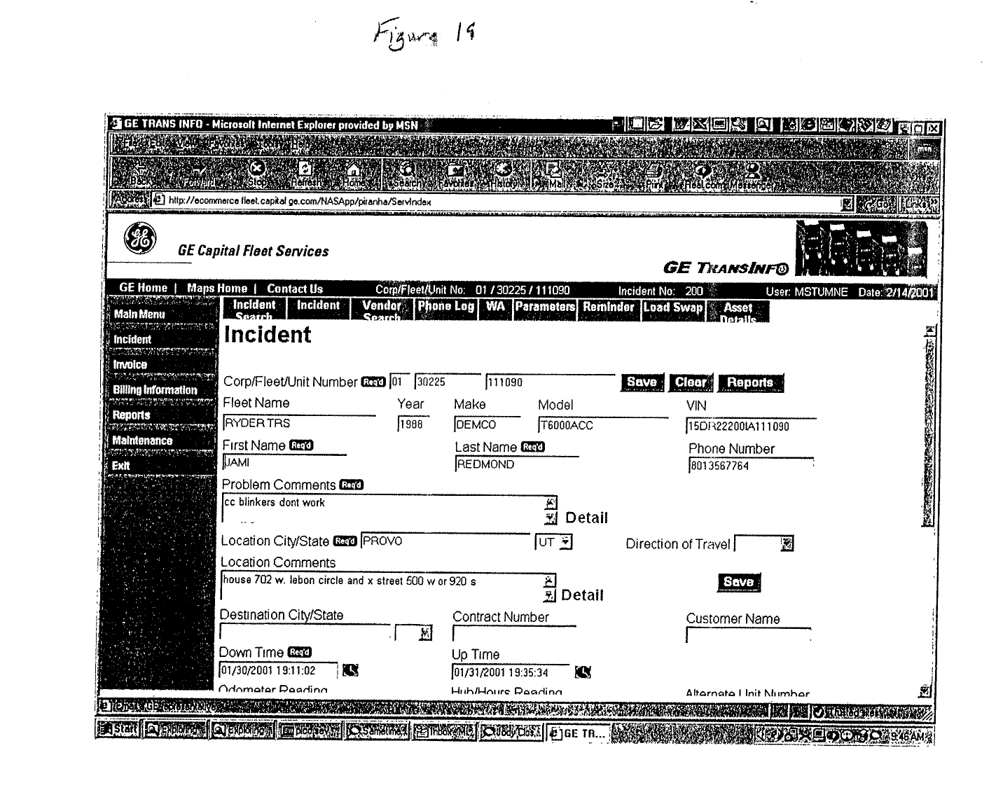

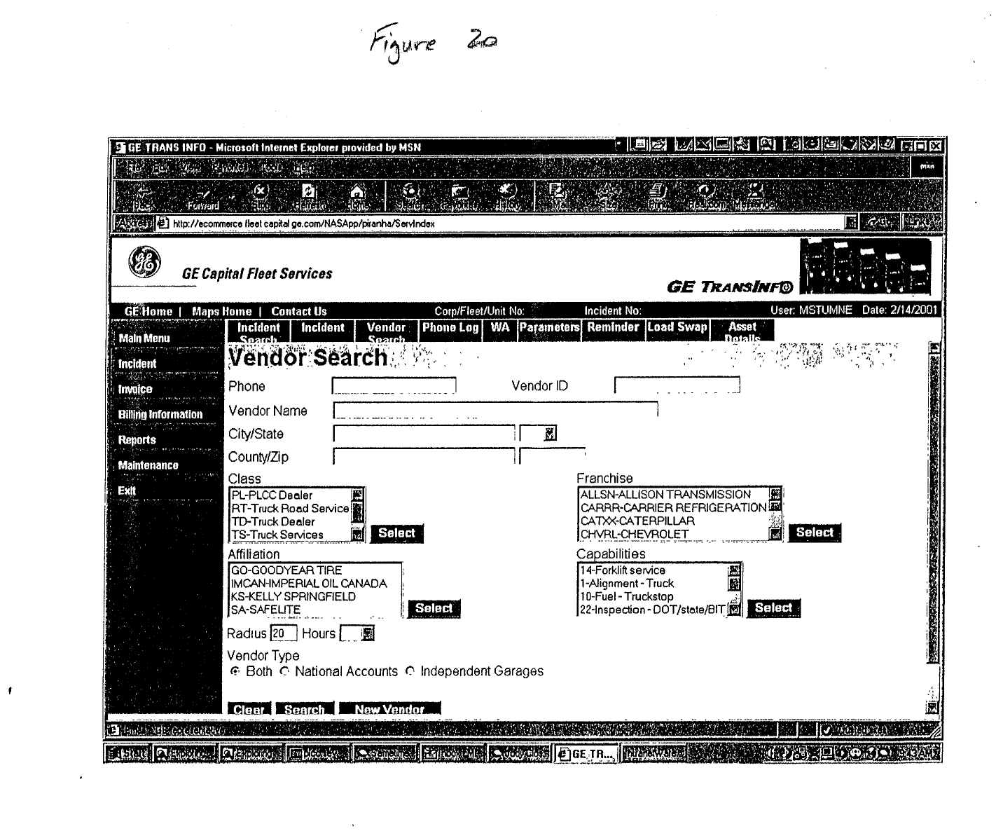

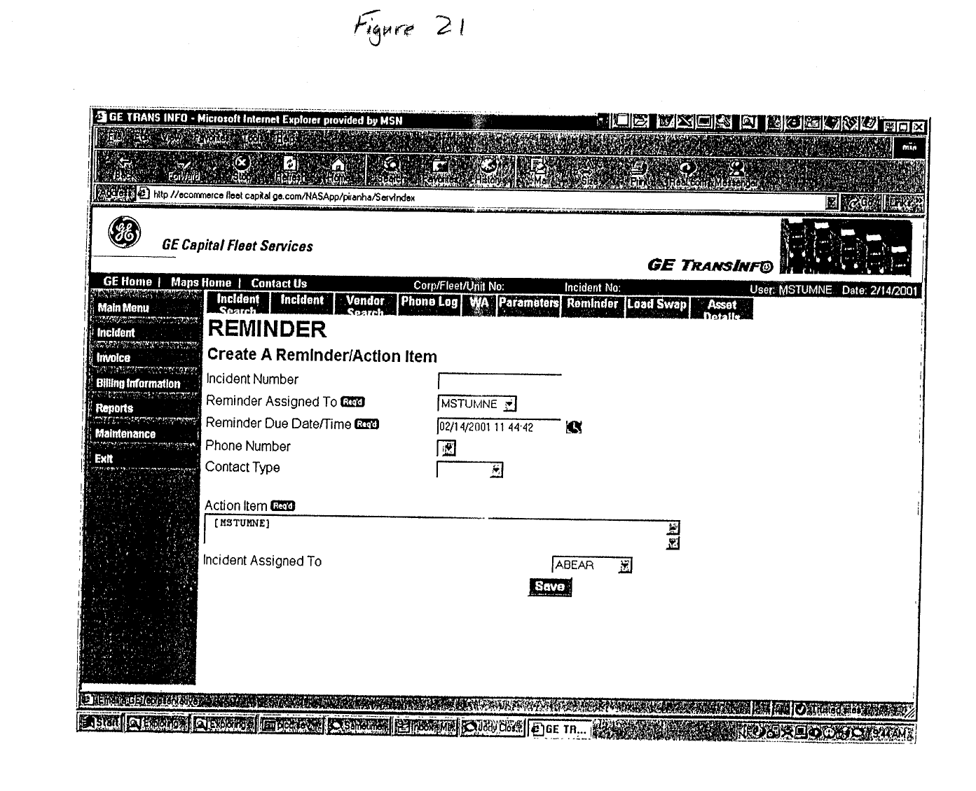

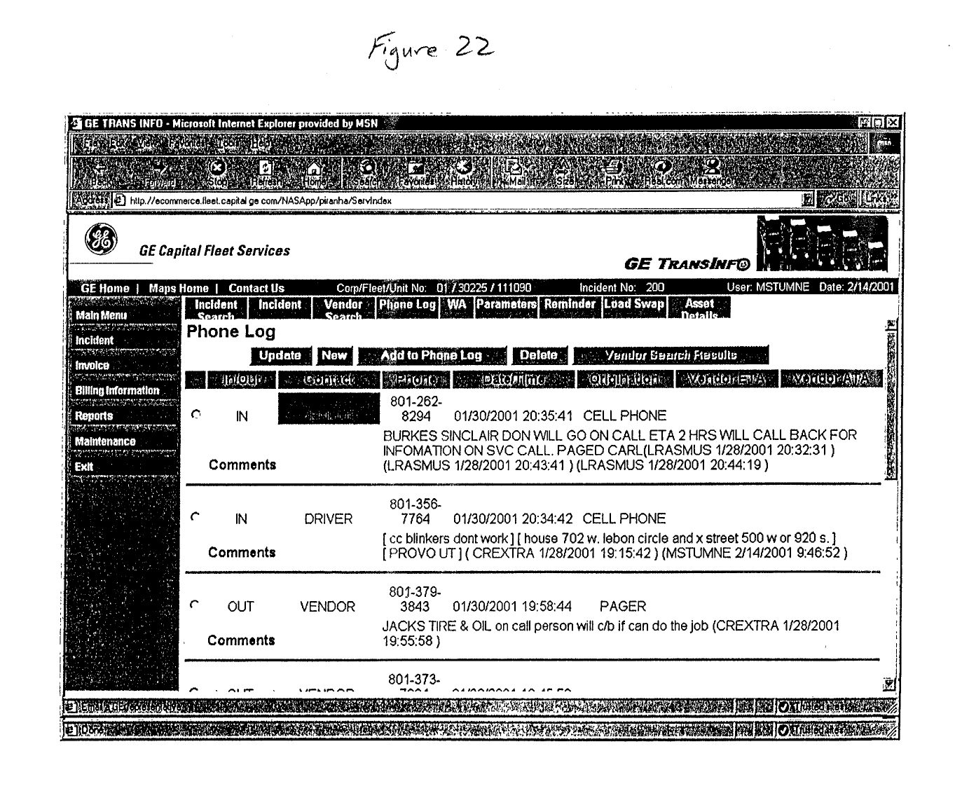

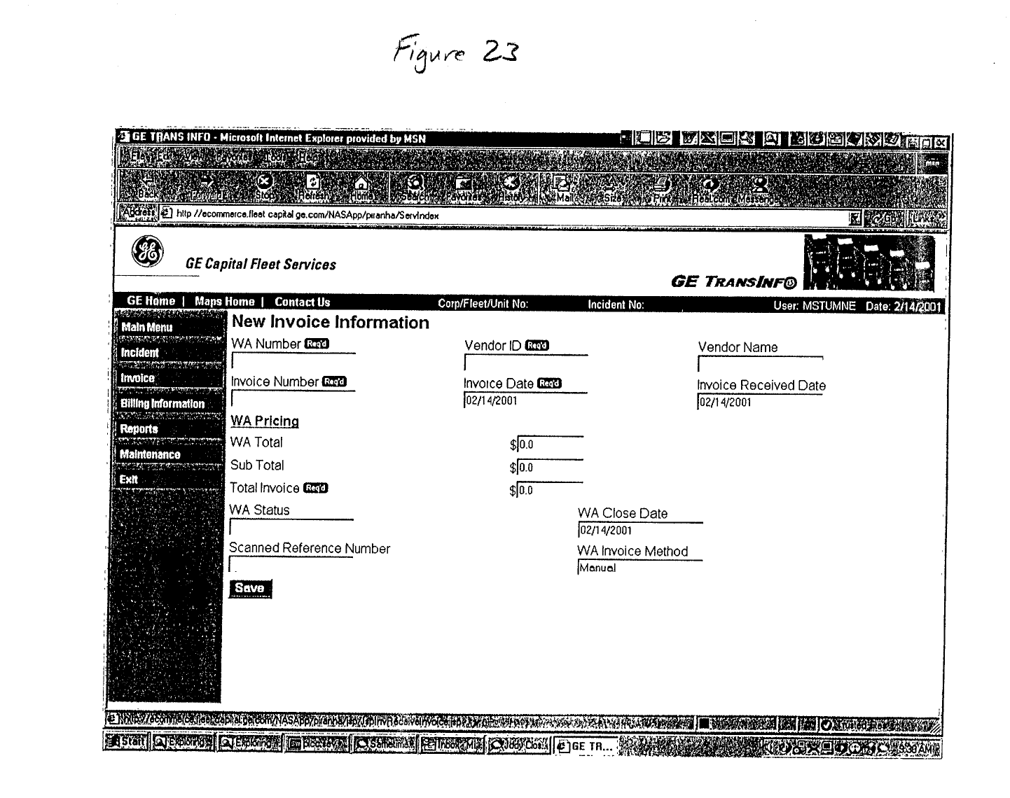

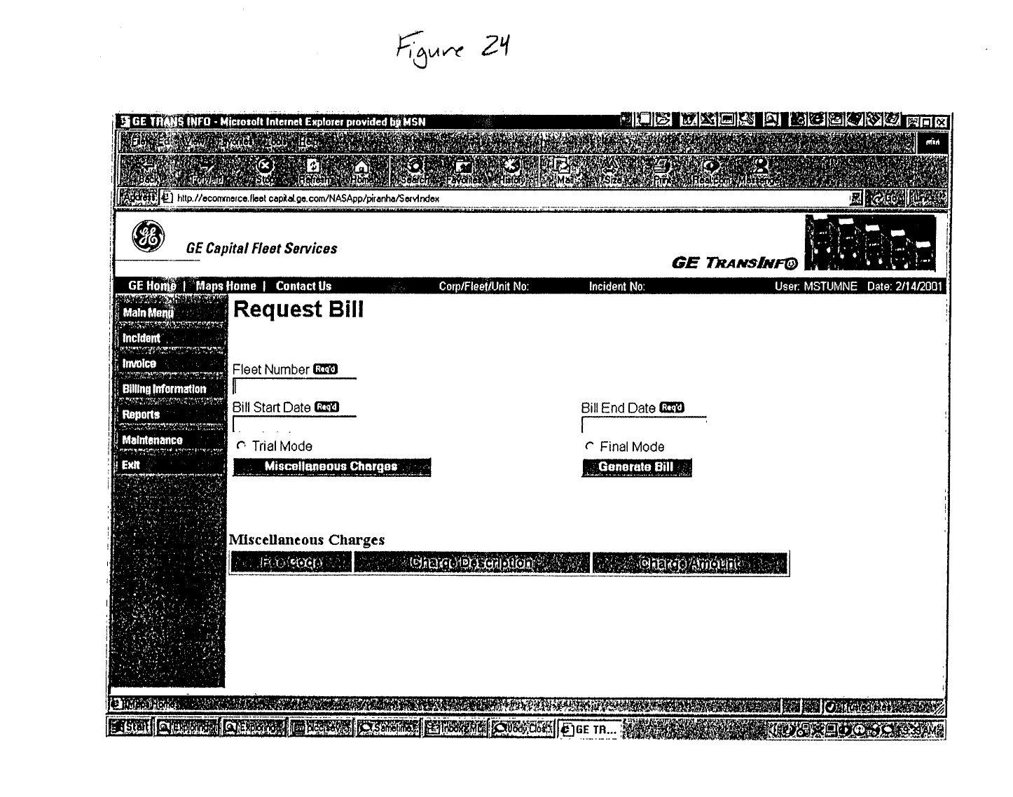

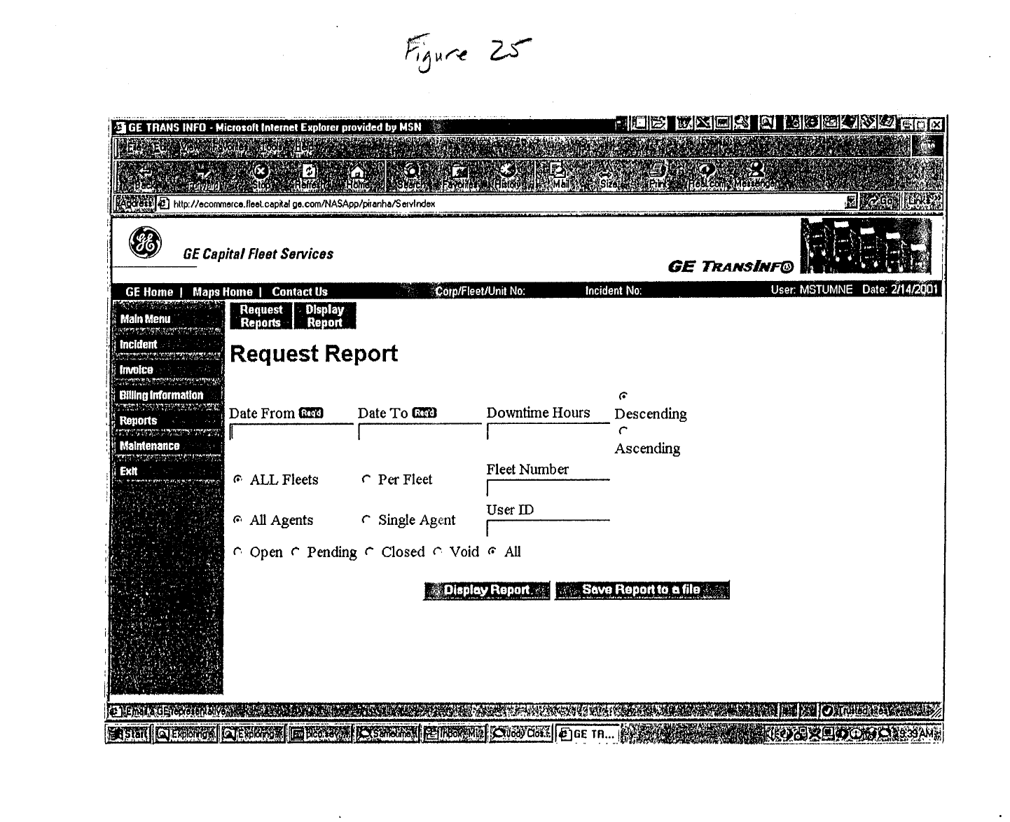

One embodiment of the present invention provides an interactive browser interface for the advisor or other user. The interface varies according to the activity. FIG. 18 shows one embodiment of a search interface. The advisor can perform a search in any of the provided fields. The present invention also provides an incident interface for the advisor to review any incident. One embodiment of an incident interface is depicted in FIG. 19. FIG. 20 depicts one embodiment of a vendor search interface. FIG. 21 shows an embodiment of the interface providing for the creation of a reminder. The present invention allows the advisor to record every phone contact in a phone log. One embodiment of a phone log interface is illustrated in FIG. 22. The advisor may input new invoice information. An embodiment of a new invoice information interface is shown in FIG. 23. FIG. 24 depicts one embodiment of a bill request interface, while FIG. 25 depicts one embodiment of a report request interface.

### B. System

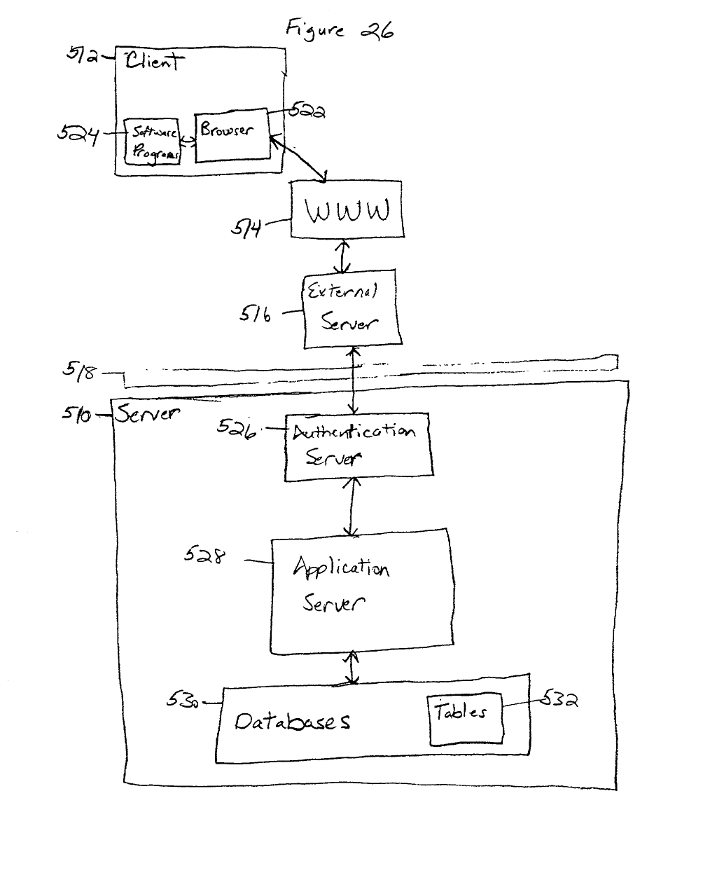

FIG. 26 is a block diagram illustrating a network-based roadside assistance management system according to one embodiment of the present invention. As shown in FIG. 26, the system includes one or more servers 510, one or more clients 512, and a communication path 514, which allows for communication between the one or more servers 510 and the one or more clients 512, such as personal computers or telephones. FIG. 26 illustrates a user interface device as the client 512. In various embodiments, the client includes a client computer, a touch tone telephone, or another interface device known to those skilled in the art. The communication path in one embodiment is a direct dial connection. In other embodiments, the communication path includes the Internet or World Wide Web (“WWW”) 514, or other suitable telecommunications path. In one embodiment, a suitable network protocol such as the TCP/IP protocol is used for the communications. Communications are performed in one embodiment by voice interactive technology known in the art. In other embodiments, communications are performed by pushbutton commands.

In some embodiments, the server 510 includes Web servers and application servers. In one embodiment, the Web server and the application server are separate entities. In other embodiments, the Web and application servers exist within a single computer or computer system. This specification will refer to both possibilities as server 510. The server 510 allows access by the clients 512 to various network resources. FIG. 26 also illustrates an external server 516, which in some embodiments is a separate computer from the server 510. In FIG. 26, this external server 516 is separated from the server 510 by a firewall 518. The firewall 518 protects the server 510 from the WWW. In one embodiment, the firewall 518 is any common or custom firewall known to those skilled in the art.

In one embodiment, any number of clients 512 are connected to the server 510 at any given time. In this embodiment, advisors access the system using a client 512. In another embodiment, a vendor accesses the system of the present invention through a client 512 to submit invoice information or for some other purpose. In a further embodiment, a customer uses a client 512 to access the system for the purpose of obtaining information regarding a particular incident or for some other purpose. In still other embodiments, other entities such as an operator or insurance entity use a client 512 to retrieve relevant information. In some embodiments, therefore, a number of users, including but not limited to advisors and other internal users, vendors, or customers (using clients 512 at remote locations), access and use the server 510 in order to carry out the invention.

### 1. The Client-Side

As shown in FIG. 26, the client 512 includes be a touch tone telephone or some other user interface device. In other embodiments, the client 512 is a client computer, including any computer or computers used by those skilled in the art. The client computer 512 comprises a central processor unit (“CPU”) and main memory, an input/output interface for communicating with various databases, files, programs, and networks (such as the Internet), and one or more storage devices. The storage devices include disk drive devices or CD ROM devices. The client computer 512 of the present embodiment includes a monitor or other screen device and an input device, such as a keyboard or a mouse. To carry out the present invention over the Internet in one embodiment, the client computer 512 has software programs contained in the main memory or the storage devices which can be used by the CPU.

In one embodiment of the present invention, the client browser 522 is a Web browser, which is a known software tool used to access the Web via a connection obtained through an Internet access provider. In one embodiment, the client browser 522 is part of the software programs 524 on the client computer 512. A variety of browsers known to those skilled in the art are used within the scope of the present invention, including Netscape Navigator, Microsoft Internet Explorer, or Mosaic browsers. As explained above, a Web server may allow access to so-called “Web sites” and “Web pages.” Once the Web browser has accessed these pages through the Web server, the HTML page may be downloaded through the input/output interface. The central processing unit may use the browser software package to interpret the information and display it on the monitor.

The software programs 524 on the client computer 512 may also contain other software or programs which will allow the user to fill in information on the screens and to exchange data with the server 510. The programs 524 on the client computer 512 may also contain emergency assistance software in order to track, manage, and assist an emergency situation.

In one embodiment, the user interacting with the client 512 is an internal user such as an advisor. In other embodiments, the user is an external user such as a vendor or customer.

### 2. The Server-Side

As shown in FIG. 26, the server 510 includes one or more software programs that run on the server-side to process requests and responses from the user's interface. In one embodiment, the software programs send information to the client computer 512, perform compilation and storage functions, and generate reports that are used by either the client or the system administrator. If the Internet is the user's interface, then the server 510 of one embodiment sends web pages in HTML format for the user to download and interpret with his/her computer and view on a monitor.

Various embodiments of the server 510 are set up in a variety of different formats to perform the functions of the invention. In FIG. 26, the server 510 contains one or more authentication servers 526 to interface with the WWW and one or more application servers 528 and one or more databases 530. In one embodiment, the authentication server 526 acts as a filter, allowing server access only to authorized clients 512. The authentication server 526 further matches the login identification of the user with the access rights of that identification, thus providing the proper views for the user. In the present embodiment, the application server 528 performs the incident tracking, invoicing, billing, automatic calculating and updating, and other functions for the system and method of the invention. In one embodiment, the application server 528 is programmed with software to perform the processes shown in FIGS. 1 through 17. The databases 530 of one embodiment contain a variety of information, including information regarding various documents and tables 532 used by the system and method of the invention, in addition to information regarding clients, incidents, vendors, work authorizations, etc.

The user carries out the present invention by accessing the application 528 through the client 512. The application 528 accesses one or more of the databases 530 to perform such functions as incident tracking and vendor selection.

What is claimed is:

1. A method for managing an emergency assistance system including interaction between an operator a vendor and a customer, the method comprising:
(a) receiving incident information from the operator and storing the incident information in an incident tracking file;
(b) receiving first invoice information from the vendor; and
(c) verifying the first invoice information and generating a bill for the customer.

2. The method of claim 1, further comprising the step of generating a report from at least the incident information.

3. The method of claim 1, wherein the incident information is received from the operator.

4. The method of claim 1, further comprising the step of searching for and selecting the vendor using the incident information and recording any vendor contact information, the vendor contact information becoming a part of the incident tracking file.

5. The method of claim 1, further comprising the step of automatically creating at least a portion of the incident information, wherein the automatically created incident information originates from previously entered incident information.

6. The method of claim 1, further comprising the step of automatically generating at least a portion of a work authorization file, the work authorization file comprising second invoice information and at least a portion of the incident information.

7. The method of claim 6, wherein the step of verifying the first invoice information further comprises comparing the first invoice information to the second invoice information.

8. The method of claim 1, wherein the step of verifying the first invoice information further comprises the step of electronically directing the vendor to an advisor when a discrepancy exists.

9. The method of claim 1, wherein the incident information originates at least in part from an incident notification call.

10. The method of claim 1, further comprising the step of searching for specific incident information.

11. The method of claim 1, wherein the step of verifying the first invoice information and generating a bill further comprises electronically routing the verified invoice information to an accounts payable system.

12. The method of claim 1, wherein the step of verifying the first invoice information and generating a bill further comprises transmitting the bill to the customer.

13. The method of claim 1, further comprising the step of recording and storing load swap information.

14. The method of claim 13, further comprising the step of automatically generating at least a portion of the load swap information from previously received and stored information.

15. The method of claim 1, further comprising the step of recording and storing any communication between a user and an external entity.

16. The method of claim 15, wherein the step of recording and storing any communication further comprises creating a phone log and storing the communication in the phone log.

17. The method of claim 1, further comprising the step of creating an automatic reminder to be displayed at a designated time.

18. The method of claim 17, wherein the automatic reminder is automatically displayed at the designated time.

19. A method for managing a roadside assistance system providing interaction assistance among an operator, a vendor, and a customer, the method comprising:
(a) receiving incident information from the operator and selecting the vendor from a database, the selecting step being based on the incident information;
(b) contacting the vendor to provide the vendor with at least a portion of the incident information and obtain vendor information;
(c) generating a work authorization based at least in part on the incident information and the vendor information, wherein the incident information is automatically transferred to the work authorization;
(d) receiving invoice information from the vendor and automatically verifying the invoice information with respect to the incident information, and transmitting the invoice information to an external site; and
(e) generating a bill based on the invoice and incident information and transmitting the bill to the customer.

20. The method of claim 19, further comprising the step of generating a report, the report comprising roadside assistance information.

21. The method of claim 20, wherein the roadside assistance information comprises at least a portion of the incident information.

22. The method of claim 20, wherein the roadside assistance information comprises at least a portion of the invoice information.

23. The method of claim 20, wherein the report is automatically generated.

24. The method of claim 20, wherein the report is generated by request.

25. The method of claim 19, further comprising the step of searching the incident information for specific incident information.

26. The method of claim 19, wherein the step of selecting a vendor further comprises searching for the vendor.

27. The method of claim 26, wherein the step of searching for the vendor further comprises searching by a city/state limitation.

28. The method of claim 26, wherein the step of searching for the vendor further comprises searching by a location and radius limitation.

29. The method of claim 19, further comprising the step of recording and storing load swap information, wherein at least a portion of the load swap information is automatically generated from at least a portion of the incident information.

30. The method of claim 19, further comprising the step of recording and storing any communication related to the incident information.

31. The method of claim 19, further comprising the step of accessing customer parameter information, wherein the customer parameter information establishes parameters for at least some discretionary incident decisions.

32. The method of claim 31, further comprising the step of updating the customer parameter information.

33. The method of claim 19, further comprising the step of accessing asset information, wherein the asset information provides specific information regarding any involved equipment.

34. The method of claim 33, further comprising the step of updating the asset information.

35. The method of claim 19, wherein the automatic verification is accomplished by comparison of the invoice information with the incident information.

36. The method of claim 19, wherein the invoice information is received via the Internet.

37. The method of claim 19, wherein the invoice information is received via telephone.

38. The method of claim 19, wherein the invoice information is received via mail and inputted by an internal user.

39. The method of claim 19, wherein the external site is an external payment system.

40. The method of claim 19, wherein the step of transmitting the invoice information to an external site further comprises the step of generating a payment instrument, wherein the external site is the vendor.

41. The method of claim 19, wherein the bill is automatically generated.

42. The method of claim 19, wherein the bill is generated by request.

43. The method of claim 19, wherein the step of generating a bill includes reviewing and finalizing the bill.

44. The method of claim 43, wherein the step of reviewing and finalizing the bill includes electronically generating and examining a bill detail file and a bill summary file.

45. The method of claim 19, further comprising the step of creating an automatic reminder to be displayed at a designated time.

46. The method of claim 45, wherein the automatic reminder is automatically displayed at the designated time.

47. The method of claim 46, wherein the automatic reminder is displayed for a user.

48. An automated system for emergency assistance, the system comprising:
(a) at least one client;
(b) a server comprising memory, a processor, an incident database, and an invoice database, wherein the processor contains at least one program to perform the following acts:
(i) receiving incident information, storing the incident information in the incident database, and tracking the incident information,
(ii) automatically creating at least a portion of the incident information, wherein the automatically created incident information originates from previously entered incident information,
(iii) receiving invoice information from an external source, storing the invoice information in the invoice database, automatically verifying the invoice information, and transmitting the invoice information to a first external site,
(iv) generating and transmitting a bill to a second external site, wherein the bill is generated from the invoice information and a portion of the incident information, and
(v) generating a report, the report comprising stored information; and
(c) a communication path electronically linking the at least one client to the server.

49. The automated system of claim 48, wherein the stored information comprises at least a portion of the incident information.

50. The automated system of claim 48, wherein the stored information comprises at least a portion of the invoice information.

51. The automated system of claim 48, wherein the first external site is an external payment system.

52. The automated system of claim 48, wherein the act of transmitting the invoice information to a first external site further comprises the act of generating a payment instrument, wherein the first external site is a vendor.

53. The automated system of claim 48, wherein the second external site is an external billing system.

54. The automated system of claim 48, wherein the second external site is a customer.

55. The automated system of claim 48, wherein the report is automatically generated.

56. The automated system of claim 48, wherein the report is generated by request.

57. The automated system of claim 48, wherein the bill is automatically generated.

58. The automated system of claim 48, wherein the bill is generated by request.

59. The automated system of claim 48, wherein the act of automatically verifying the invoice information is accomplished by comparison with the work authorization information.

60. The automated system of claim 48, wherein the external source is an external user.

61. The automated system of claim 48, wherein the external user is a vendor.

62. The automated system of claim 48, wherein the communication path is an Internet-based electronic network.

63. The automated system of claim 48, wherein the communication path is a telephone.

64. The automated system of claim 48, wherein the communication path is accessed by an internal user.

65. The automated system of claim 48, wherein the communication path is accessed by an external user.
